(19) United States
(12) Patent Application Publication
(10) Pub. No.: US 2005/0198508 A1
(43) Pub. Date: Sep. 8, 2005

(54) Method and system for transmission and processing of authenticated electronic mail

(76) Inventor: Stephen Howard Beck, Monte Sereno, CA (US)

Correspondence Address: N.R.H. Black P.E., 420 Miramontes Ave., Half Moon Bay, CA, 94019, US

(21) Appl. No.: 10/795,147

(22) Filed: Mar. 4, 2004

(51) Int. Cl. H04L 9/00

(52) U.S. Cl. 713/170

(57) ABSTRACT

Embodiments of the present invention may provide a method, systems and/or computer program products for an e-mail messaging system. This may involve providing multiple authenticated e-mail systems each controlled by programmed instructions. E-mail messages may be digitally signed and signatures may be validated. Conformance to rules may be enforced and errant accounts deactivated. Non-conforming messages may be slow tracked and abuse may be reported to a certificate authority.

### FIELD OF THE INVENTION

The present invention pertains generally to the field of computer security and more specifically to the authentication of e-mail (electronic mail) systems.

### BACKGROUND OF THE INVENTION

By some current estimates (end of 2003), there are approximately 500 million e-mail inboxes worldwide and roughly 45 million e-mail domains. E-mail has all but replaced the conventional post and to a lesser extent the telephone, as the communication vehicle of choice at least among the growing ranks of the digerati. With the proliferation of e-mail has come a host of, at the least annoying, and at the worst, highly destructive scourges. Almost any user who has participated in an online newsgroup, posted their email address as required by a merchant web site, or placed their e-mail address on their business card, is probably receiving anywhere from a handful to hundreds of unsolicited advertising e-mails (also known as spam) every day. Such deluges are now considered routine and for the most part, an annoyance that accompanies the privilege of e-mail. While spam may be time consuming on an individual basis, the losses in worker productivity, wasted storage and Internet bandwidth required by mail servers to carry the extra traffic add up to billions of dollars per annum. In addition, consumers, most notably parents of young children, are becoming increasingly upset with the volume and content of spam and have begun to disengage from e-mail, presenting a problem to those ISPs (Internet Service Providers) who depend on consumers for their business. Finally, beyond the problems posed by spam, malevolent software viruses, computer worms, and computer Trojans are also wreaking havoc with Internet computer systems costing lots of money annually.

The cost to spammers (entities that create spam) for executing their bulk mailing is negligible relative to the return—dramatically cheaper and faster than postal mail. Legislation passed to curb spam has quickly proven ineffective, since the anonymity of spam, not to mention its increasingly offshore nature, makes it extremely difficult to prosecute. Virus writers also benefit from the anonymity of the Internet to launch their attacks, typically to an initial distribution list from which propagation can accelerate at a geometric or exponential level.

A root problem that enables spammers and virus developers to succeed is the promiscuous nature of SMTP (simple mail transfer protocol); no authentication is required to send an e-mail to millions of addresses, so there is no mechanism to enforce accountability. SMTP is well known in the Internet ails. Spammers direct their prospective customers to web sites and phone numbers and do not respond to reply e-mails. Therefore, they may make up as many unique and bogus return e-mail addresses as they wish, and the current Internet mail specifications do not prevent this.

Much current anti-spam technology relies on message filtering—attempting to detect patterns in the message after it has been received that would strongly suggest spam, possibly combined with some rudimentary test that the e-mail domain from which the e-mail ostensibly originated actually exists. Such approaches may be relatively effective on a temporary basis, but spammers adapt quickly with so much at stake, thus perpetuating a cat and mouse game that offers insufficient lasting relief to ordinary users.

Another area of art in attempting to combat spam is what is known as challenge/response. Upon receipt of a message from an unknown sender, the system may automatically generate a challenge to the sender to confirm that a human being sent it. The message is not delivered until the sender responds, at which point not only is the message delivered, but the sender is added to a trusted list of senders. While challenge/response is ostensibly effective at curbing spam, it has disadvantages. For example: (a) it proves an imposition on ordinary users attempting to interact via e-mail, forcing them to add a potentially time consuming step to the process (consider a time-critical e-mail that is now held waiting for the response to the challenge). (b) Spammers, sufficiently motivated to keep up their trade, will in time find ways to defeat challenge/response, for example by providing potentially valid return addresses from which they may automate responses.

There are also legitimate bulk marketers who are willing to conform to rules and guidelines that enable end-consumers to avoid the annoyance and costs of spam through art implementing such capabilities. Such rules and guidelines include for example implementation of “opt-in” lists and special tags on Subject lines rendering it possible for intelligent filtering to succeed easily.

### SUMMARY

According to an aspect of the invention an e-mail messaging system is provided. The e-mail messaging system may comprise first and second authenticated e-mail system each controlled by programmed instructions. One authenticated e-mail system may validate unsigned messages for, inter alia, originating user conformance to rules. Messages may be digitally signed and sent to another authenticated e-mail system. An authenticated e-mail system may receive digitally signed messages and verify them either fast tracking or diverting the message accordingly.

According to a further aspect of the invention a software system or product comprising a set of computer executable codes embodied on a computer-readable medium for a message storage system may be provided. Such software system may be used, inter alia, to embody an e-mail messaging system according to an embodiment of the invention.

According to a still further aspect of the invention a method an e-mail messaging system may be provided.

Further aspects of the invention disclose rules that may be used to detect spamming, excessive message volumes and/or the use of revoked or otherwise invalid digital certificates.

Still further aspects of the invention disclose systems and methods for reporting and suppressing abuse of e-mail services.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 of the drawings is a block diagram showing an embodiment of an authenticated e-mail environment according to an embodiment of the invention between two authenticated domains;

FIG. 2 of the drawings is a block diagram showing a preferred embodiment of the authenticated e-mail environment in which an unauthenticated domain communicates with an authenticated e-mail environment.

FIG. 3 of the drawings is a flowchart illustrating an embodiment of the authenticated e-mail environment in which an e-mail message is transmitted with a digital signature and send-side policy enforcement according to an embodiment of the invention.

FIG. 4 of the drawings is a flowchart illustrating an embodiment of the authenticated e-mail environment in which e-mail messages are received and processed according to an embodiment of the invention.

FIG. 5 of the drawings is a flowchart illustrating errant account deactivation according to an embodiment of the invention.

FIG. 6 of the drawings is a flowchart illustrating an embodiment of the authenticated e-mail environment in which a certificate chain is validated and a message signature verified according to an embodiment of the invention.

FIG. 7 of the drawings is a flowchart illustrating an embodiment of the authenticated e-mail environment in which a sender's certificate is checked for revocation according to an embodiment of the invention.

FIG. 8 of the drawings is a block diagram showing a preferred embodiment of the authenticated e-mail environment in which a user reports abuse according to an embodiment of the invention.

FIG. 9 of the drawings is a flowchart illustrating the operation of an abuse-reporting site of the receiving side of the authenticated e-mail environment according to an embodiment of the invention.

FIG. 10 of the drawings is a flowchart illustrating the operation of the CA's abuse reporting site according to an embodiment of the invention.

FIG. 11 of the drawings is a flowchart illustrating the operation of the abuse reporting site of the authenticated e-mail environment according to an embodiment of the invention.

FIG. 12 of the drawings is a block diagram showing an exemplary certificate chain and certificate contents according to an embodiment of the invention.

### DETAILED DESCRIPTION OF THE PREFERRED EMBODIMENTS

In the following detailed description of exemplary embodiments of the invention, reference is made to the accompanied drawings, which form a part hereof, and which are shown by way of illustration, specific exemplary embodiments of which the invention may be practiced. For purposes of clarity and conciseness of the description, not all of the numerous components shown in the schematics and/or drawings are described. The numerous components are shown in the drawings to provide a person of ordinary skill in the art a thorough, enabling disclosure of the present invention. The operation of many of the components would be understood and apparent to one skilled in the art. The embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

Throughout the specification and claims, the following terms take the meanings explicitly associated herein, unless the context clearly dictates otherwise.

Terms and Definitions.

The term authenticated e-mail followed either by system or environment is understood to refer to at least one system within an embodiment of the present invention.

The terms e-mail domain and e-mail server are used to refer to at least one single e-mail server system wherein users' accounts have mailboxes.

The term digital signature is understood to refer to a cryptographic process wherein a cryptographic hash is taken of a document, an e-mail message or digital certificate in this context, and the hash value encrypted using the private key of the entity that is signing the document. The entities in the context of this document are understood to be CAs (Certification Authorities) and e-mail servers.

Verification of a digital signature is understood to refer to the inverse of the digital signature process—a cryptographic process wherein a recipient of a signed message uses the ostensible sender's public key. This is typically authenticated and parsed from the sender's digital certificate, to decrypt the signature thus resulting in the hash created by the sender as per supra. The recipient may then perform the same hashing function on the original message in the same manner as did the sender per supra and compares the two values. If they match, the signature is verified implying that the message did not change between transmission and receipt and that the ostensible sender was indeed the actual sender. If the two hashes don't match, the signature does not verify, and either or both of the aforementioned conditions failed.

The term digital certificate is understood to refer to a data structure, typically stored in a disk file, that binds the identity of an entity to their public key through the digital signature created by a CA (Certification Authority).

The terms Certification Authority and CA refer to a trusted third party, implemented as a software system, that is trusted to issue and digitally sign digital certificates to a community of cooperating users, in this case, e-mail account users in which the authenticated e-mail system is deployed.

The term Root CA is understood to refer to the top of the CA hierarchy—the trusted third party for the global PKI (Public Key Infrastructure) governing the issuance of certificates to entities deploying all authenticated e-mail system. It is possible to have multiple root CAs whose subordinate PKIs do not intersect.

The terms certificate chain and trust chain are understood to refer to a hierarchical list of certificates, beginning with a root CA and continuing down through subordinate CAs until reaching the CA that has signed the certificate of the given end-entity, in this context an e-mail server. The chain also includes the certificate of the end-entity.

The term DMZ (de-militarized zone) is understood to refer to a subnetwork of an enterprise network that sits behind a commodity access firewall, metering access to the Internet. The DMZ is considered the “safe side” of the firewall, protected against attacks from the Internet. Generally speaking, this subnetwork will implement NAT (Network Address Translation) at the firewall in order to be able to differentiate the IP (Internet Protocol) addresses of internal and external requests. The DMZ is then separated from the enterprise internal network through a second firewall.

The term CP (Certificate Policy) is understood to refer to the publicly documented policy of a CA in the trust hierarchy of the deployed authenticated e-mail environment. At a minimum the root CA is required to publish a CP. Included within the CP will typically be policy round how to issue certificates differently to subordinate CAs, normal users, and legitimate bulk marketers.

The term CPS (Certificate Practice Statement) is understood to refer to the publicly documented set of practices a CA in the trust hierarchy of the deployed environment will implement to ensure compliance with the CP. For example, the CPS would dictate the type(s) of authentication information to be provided by a subscriber, before a certificate could be issued.

The term CRL (Certificate Revocation List) is understood to refer to a data file digitally signed and stored by a CA, typically in an LDAP (lightweight directory access protocol) compliant directory, containing a list of serial numbers of certificates issued by the CA and subsequently revoked by the CA.

The term OCSP (Online Certificate Status Protocol) is understood to refer to a protocol spoken between an entity wishing to discover revocation status on a certificate in real time with an OCSP Responder—a web based server that responds to OCSP requests.

The term offended user is understood to refer to an e-mail user who receives an e-mail from another member of the authenticated e-mail community that in his/her judgment does not conform to the policies and guidelines of the community—chiefly a spam message or like form of abuse.

The term offending user is understood to refer to a user who has sent an e-mail considered offensive by an offended user.

Overview

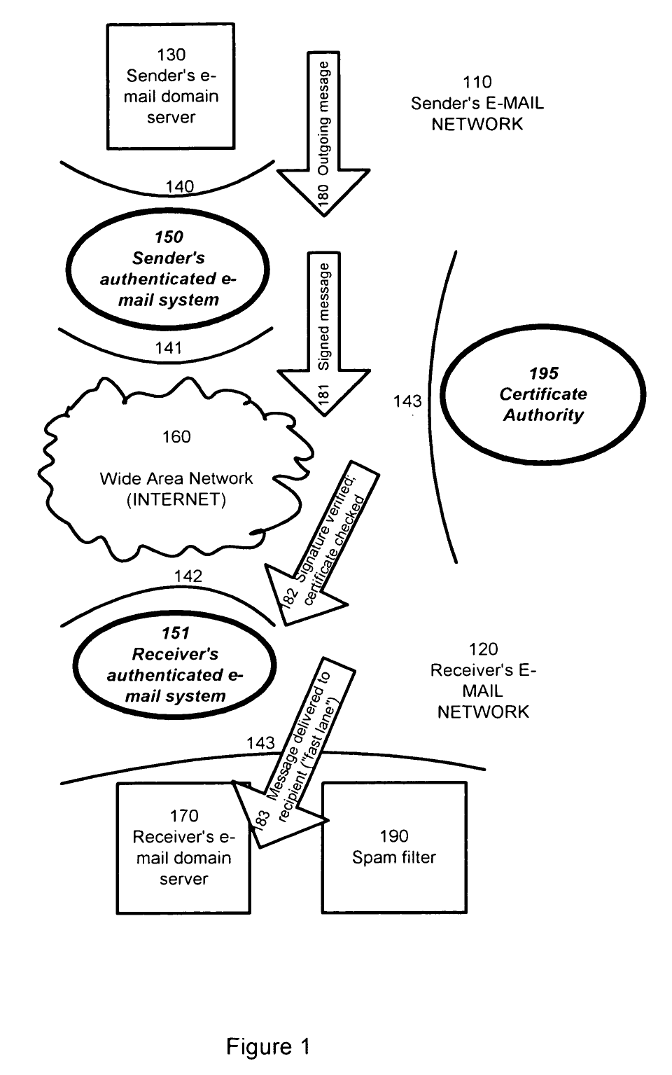

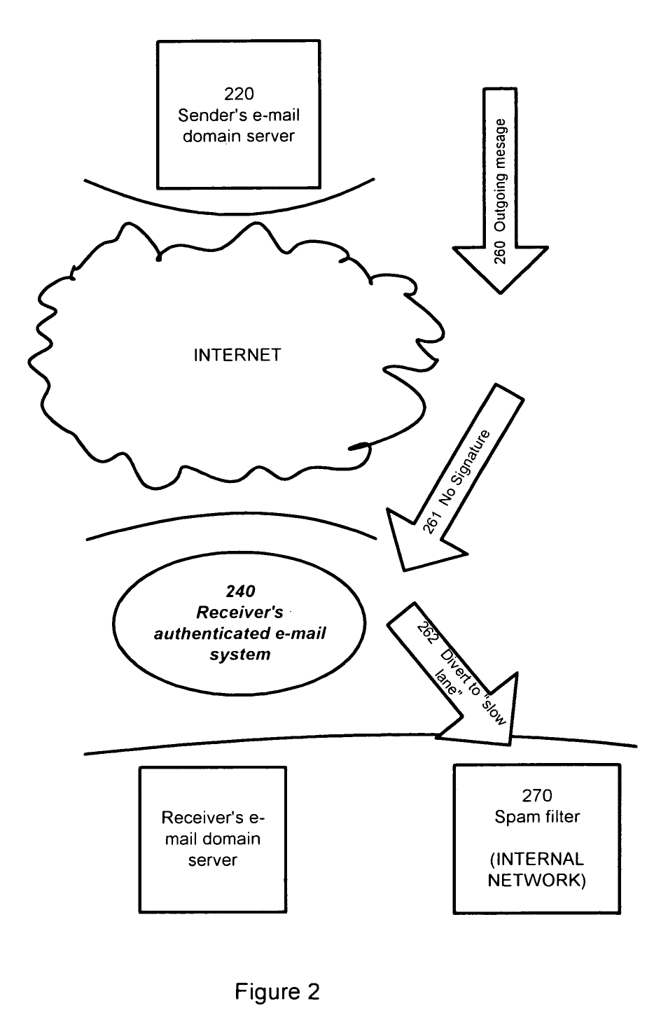

FIGS. 1 and 2 of the drawings show components of an exemplary environment in which the invention may be practiced. Not all the components may be required to practice the invention, and variations in the arrangement and type of the components may be made without departing from the spirit or scope of the invention.

Illustrative Operating Environment

FIG. 1 of the drawings shows sending e-mail network 110 and receiving network 120 coupled by way of a Wide Area Network (WAN) 160 such as the Internet. Disposed between the Internet 160 and e-mail networks 130 and 170 are commodity access firewalls 141 and 142 and instances of the authenticated e-mail system hereunder, 150 and 151. E-mail network 110 is coupled to the Internet 160 only by access firewall 141. Commodity access firewalls 140 and 143 couple the authenticated e-mail systems 150 and 151 to the conventional e-mail servers 130 and 170. As such there is no coupling of e-mail servers 130 or 170 directly to the Internet 160. The conventional e-mail servers 130 and 170 most likely sit on a Local Area Network (LAN) within their enterprise IT infrastructure. The authenticated e-mail systems 150 and 151 each sit in a DMZ behind a conventional access firewall 141 and 142 as the coupling of the perimeter of their internal network to the Internet 160. Within the internal network 120 of the receiving environment is a spam filter 190 that filters incoming mail to the conventional e-mail server 170.

When a sending user with an account on the sending conventional e-mail server 130 composes an e-mail message 180 to a recipient user with an account on the receiving conventional e-mail server 170, the message 180 leaves the sender's e-mail server 130, via SMTP, IMAP (Internet mail access protocol), or other transfer protocol, to the sender's authenticated e-mail system 150. Such a sending user's account is ordinarily considered to be active or activated. The account may be deactivated for various reasons including, for example, a failure to comply with applicable rules. The sender's authenticated e-mail system 150 creates a digital signature from the message 181, either in its entirety including attachments, as per the S/MIME standard, or from some specific subset of the message such as a subset of the RFC 822 headers. The signature is created using the sending authenticated e-mail system's private key to encrypt a hash of the message data being signed. The signature is then either appended as part of a standard S/MIME-format message, or it is embedded within the message as a proprietary RFC 822 header, using PKCS #7, or other standard format. This process creates a message with a verifiable digital signature uniquely from the sender 181. The sender's authenticated e-mail system 150 forwards on the signed message 181 to the e-mail domain of the recipient.

In this case, the recipient of the message is also running an authenticated e-mail system 151 that first receives the message. It first attempts to verify the digital signature on the message 182. If the signature is verified, the message is trusted as having been sent by a legitimate user of the authenticated e-mail system and is fast tracked to a configurable location 183, in this case directly to the recipient's conventional e-mail server 170.

Illustrative Operating Environment

FIG. 2 presents an exemplary environment of the authenticated e-mail system interacting with a sender that is not running an instance of the authenticated e-mail system. The sending user sends the message 260 through the conventional e-mail system 220 to the receiver's authenticated e-mail system 240.

The receiver's authenticated e-mail system finds the message unsigned 261 and being therefore unable to trust the source of the message, diverts the message to the configured “slow lane” 262, in this case, the receiving system's spam filter 270.

Illustrative Operating Environment

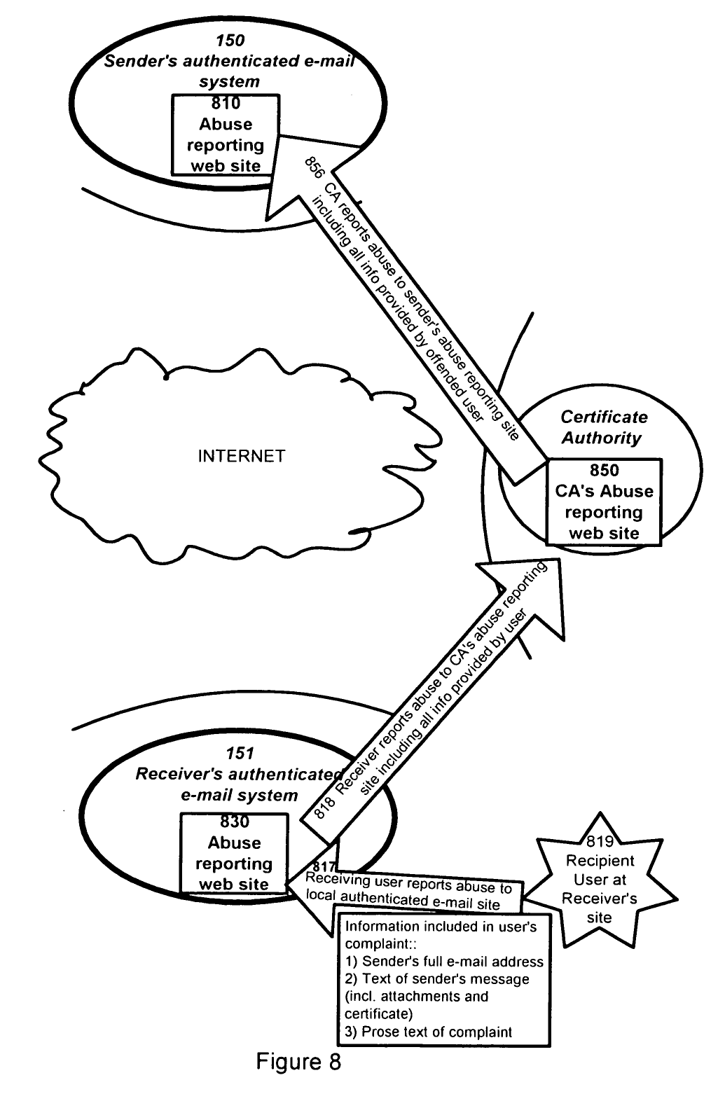

FIG. 8—shows an exemplary embodiment of the abuse reporting subsystem of the authenticated e-mail environment. A receiving user 819 receives a message that violates the policies surrounding spam and reports the abuse 817 on a web site 830 hosted by the receiver's instance of the authenticated e-mail system 151 (c.f. FIG. 1). The offended user provides the abusive sender's full e-mail address, the text of the sender's message (including any attachments and the certificate of the sending e-mail server), and prose text explaining the complaint in the user's words. The receive-side abuse reporting site 830 forwards the complaint on 818 to the CA that issued the certificate to the abusive sender's domain. The issuing CA also hosts an abuse reporting web site 850 that receives the complaint, logs the complaint, updates records on abusive senders, and forwards the complaint on 856 to the abuse reporting web site 810 hosted by the sender's instance of the authenticated e-mail system 150 (c.f. FIG. 1), where final action is taken against the user.

Process Flow for Sending a Message

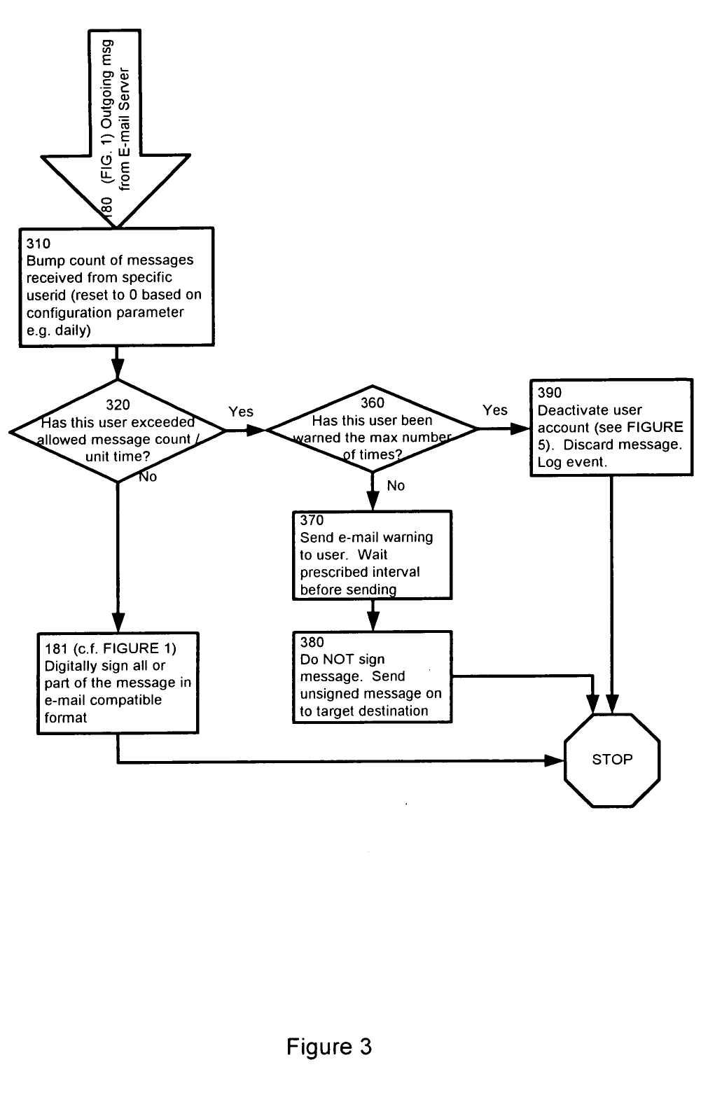

FIG. 3 presents an exemplary process flow for digitally signalling and transmitting an outgoing message. The authenticated e-mail system receives an outgoing message 180 (c.f. FIG. 1) from the conventional e-mail server, via SMTP, IMAP, or other transfer protocol. This process flow typically includes verifying compliance with applicable rules that have the effect of prohibiting spamming.

The authenticated e-mail system tracks how many messages an individual user with an account on the system sends over a configurable time period. It resets the counter on a periodic basis, also specified in the system configuration. Upon receipt of the incoming message 180, the system increments the count of the number of message received from this user per unit time 310. If the user has exceeded the allowed count per unit time 320, the user may be a spammer and will be dealt with as set out herein. If not, the system digitally signs the message using, for example, the S/MIME format (or other format) and forwards the message on to its destination 181 (c.f. FIG. 1).

If the sending user has exceeded the allowed message count per unit time, the next test is to see if the given has already been warned by the system for such inappropriate behavior. If the user has not exceeded the allowed warning count 360, a warning regarding exceeding the maximum message count per time is sent to the sending user 370, the message is not signed (in the event it is spam), it is delayed by a configured interval prior to being transmitted, and finally is sent on to its target destination 380.

If the test 360 shows that the sending user has indeed exceeded the maximum allowed warning count, severe action is taken 390. The message is discarded, and the user's account is deactivated 390. The event is logged in the system's log file.

Process Flow for Deactivating a User

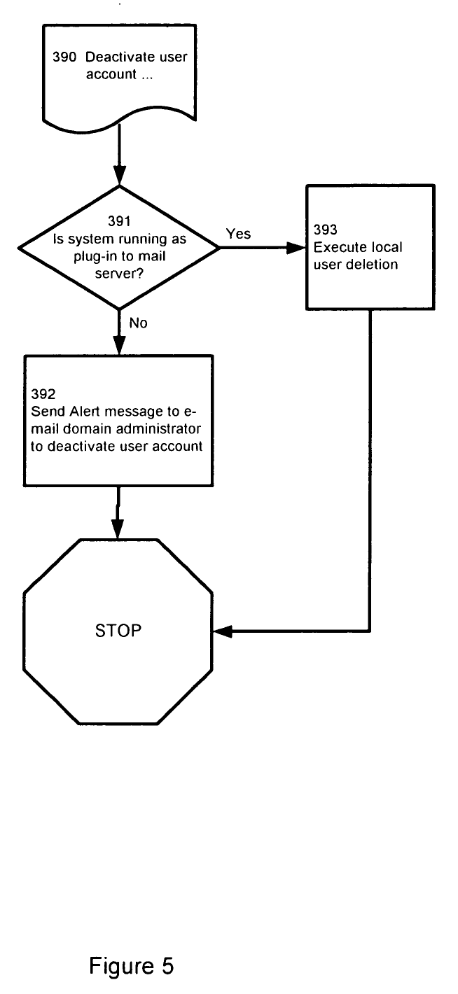

FIG. 5 presents an exemplary process flow for deactivating a user on the conventional e-mail system as enforcement of the policies in effect for proper use of the system.

According to one embodiment of the invention, the system runs as a plug-in or dynamic link library (dII) to the conventional e-mail server. As such, it operates within the processing context of the e-mail system and has access to the components thereof 391. In this embodiment, the authenticated e-mail system simply executes a delete user operation on the offering user 393. Local policy may call for locking the account first for a finite period (e.g. 30 days) as a means of keeping potentially important user files briefly available and physically deleting the account thereafter. The authenticated e-mail system conforms to the established e-mail server policy when deactivating a user.

According to another embodiment of the invention, the system may run as a proxy on a different server system than the conventional e-mail server and as such will not have direct access to the components of the conventional e-mail system 391. In this embodiment, the system sends an alert message to the conventional e-mail server 392. Such alert may in one embodiment be an e-mail message to the administrative user of the e-mail server, or in another embodiment, a write directly onto a monitored logfile of the conventional e-mail server over the network.

Process Flow for Processing an Incoming Message

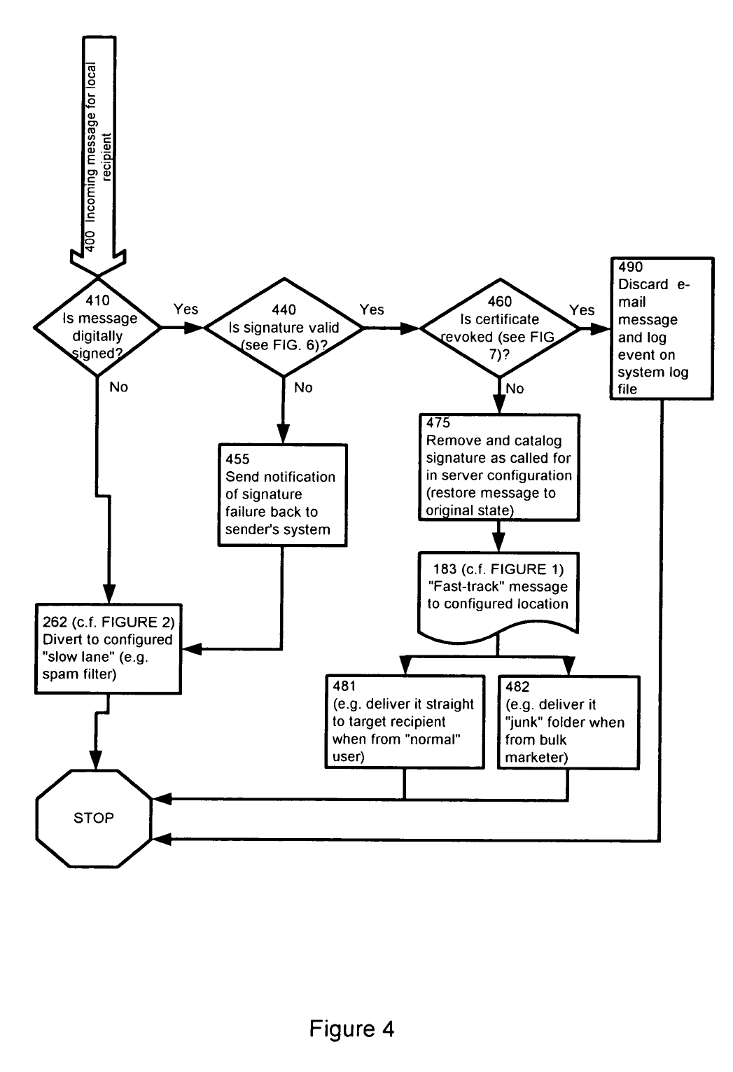

An exemplary process flow for a new message receipt as illustrated in FIG. 4 is as follows. The message 400 is received by the authenticated e-mail system via SMTP, IMAP, or other transfer protocol.

The system checks to see if the message is digitally signed 410. If not, the message is diverted to the configured “slow lane” 262 (c.f. FIG. 2). In an exemplary embodiment, the “slow lane” would be a local spam filter 190 (FIG. 1) connected to the conventional e-mail server 170 (FIG. 1).

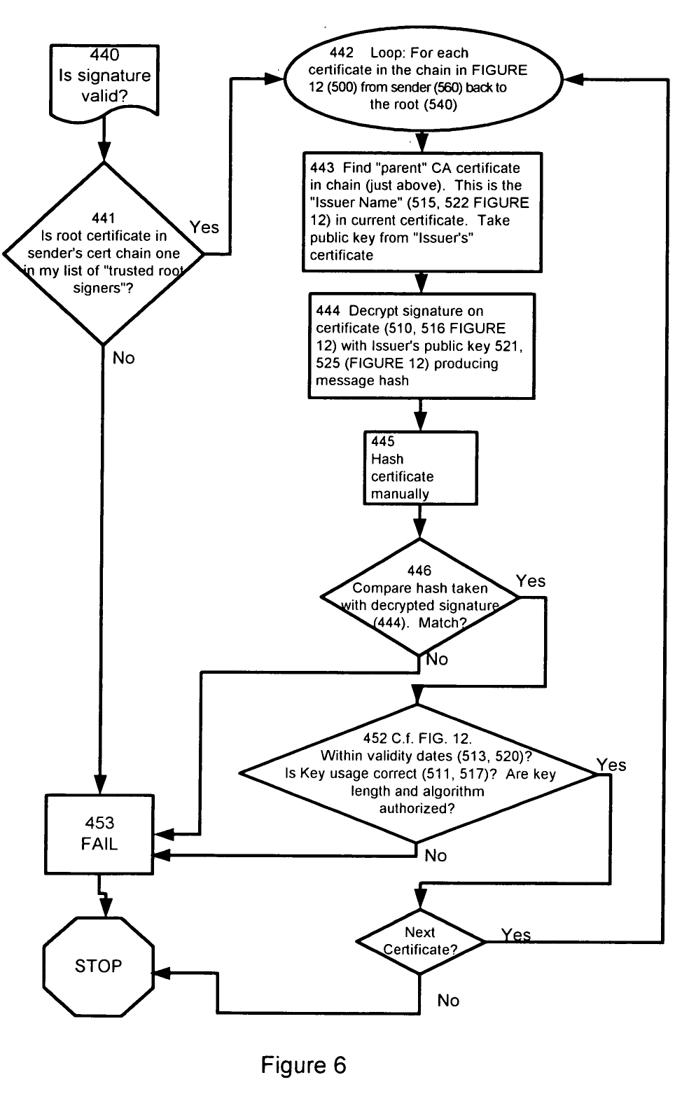

If the message is digitally signed 410, the system executes a process flow, set forth in steps 441-452 (FIG. 6) to validate the signature 440. If the signature is not valid or in any case, not trusted (which covers the case where the message is validly signed but not by a member of the trust domain of the authenticated e-mail system), the system sends a notification of the problem to the sending authenticated e-mail system or mail system administrator 455, and diverts the message to the configured “slow lane” 262 (c.f. FIG. 2).

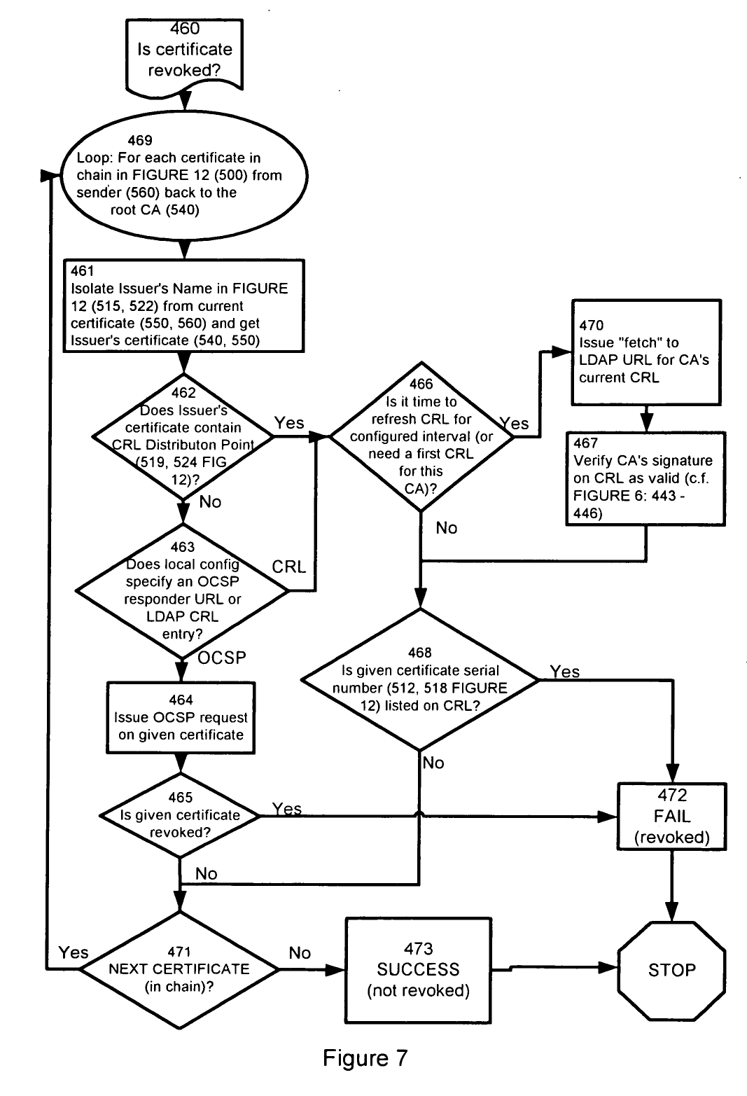

If the digital signature was successfully validated 440, the system checks to see if the sender's certificate has been revoked 460 using the process flow set forth in steps 461-473 (FIG. 7). If it has, the message is discarded and the event logged 490. No further action is take in this case.

If the certificate has not been revoked 460, the message is processed for “fast track” delivery. If the system configuration calls for removal of the signature prior to delivery to restore the message to the state in which it was originally sent, the signature is stripped off but stored in a local catalog 475. Otherwise it is delivered with the signature intact 475.

The message is then “fast tracked” per the system configuration 183 (c.f. FIG. 1). In an exemplary embodiment of the invention, if the sending system's certificate indicates that the sending users are “normal” e-mail users, the “fast track” is typically direct to the recipient's mailbox on the conventional e-mail server 481. In another embodiment of the invention, if the sending system's certificate indicates that the sending users are certified bulk marketers, the “fast track” could be a “junk” or “advertising” public folder 482 visible to all users as interested on the receiving e-mail system.

Process Flow for Validating a Digital Signature

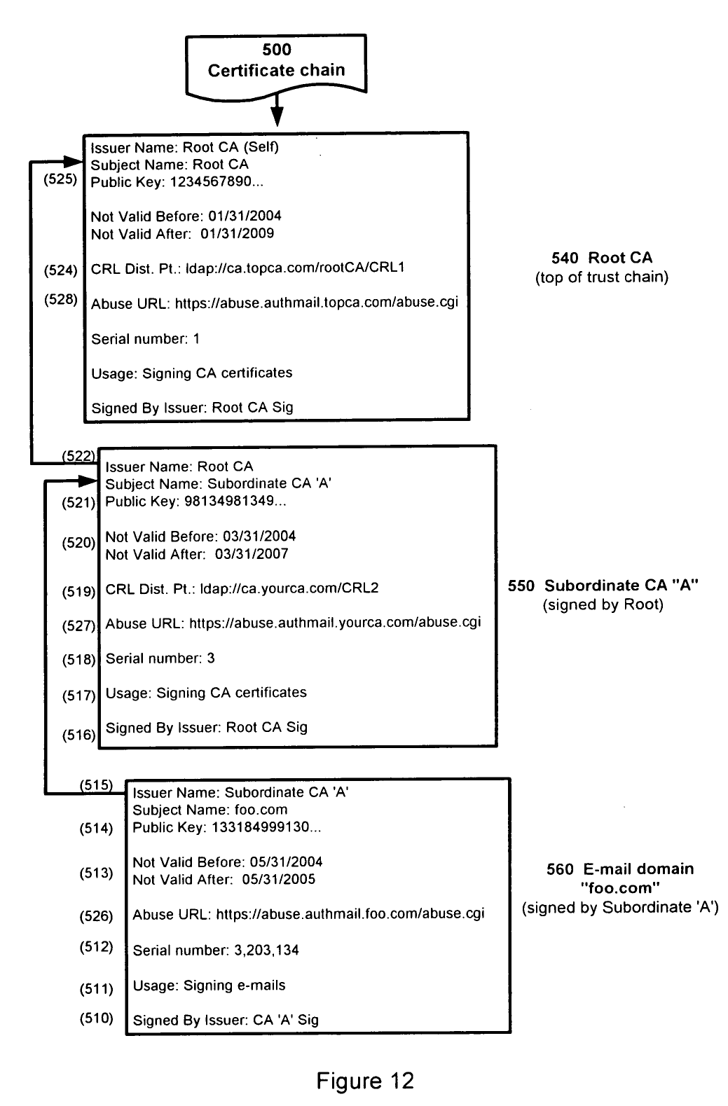

FIG. 6 presents an exemplary process flow for running verification and validation tests on the digital signature of an incoming message. In describing this process flow, reference is made to FIG. 12, an exemplary digital certificate “trust chain” block diagram providing sample contents of the digital certificates used by the authenticated e-mail system. When a message (for example, an S/MIME message) is digitally signed, it typically includes all certificates in the trust chain from the signer of the message 560 (FIG. 12), through intervening subordinate CAs, back to the root CA 540 (FIG. 12), the top of the trust chain.

FIG. 6 shows the first test 441 being whether or not the root CA certificate 540 (FIG. 12) at the top of the trust chain is a trusted root signer within the current authenticated e-mail system. The trusted root signer(s) is(are) authorized to sign subordinate CA certificates and/or e-mail server certificates within the trust domain of the environment instantiated by the authenticated e-mail system. If the root CA certificate from the message is not in the trusted signers list of the system, the entire chain is considered untrusted, since the trust environment of the certificate chain in the message is non-overlapping with the trust environment of the system. The signature is thus considered untrusted in the context of the authenticated e-mail system 453.

If the root CA certificate 540 (FIG. 12) of the certificate chain of the incoming signed message is trusted by the system, the process flow proceeds to a loop 442 that will check the validity of each certificate in the chain down to the certificate of the signing e-mail domain 560 (FIG. 12).

To check the validity of a given certificate in the chain 443, the system looks for its “parent” CA certificate—the certificate of the CA that signed the certificate being examined. The parent CA is identified in the certificate being examined, through the “Issuer Name” field 515/522 (FIG. 12). The system obtains the public key 521/525 (FIG. 12) from the parent CA certificate 540/550 (FIG. 12).

With the public key of the parent CA now available 521/525 (FIG. 12), the signature 510/516 (FIG. 12) on the certificate being examined is decrypted resulting in a hash value 444.

The next step is to hash the message manually 445, and then compare the manually taken hash with value resulting from the decryption of the signature 446. If they match, the signature 510/516 (FIG. 12) on the certificate verifies. If not, the certificate cannot be trusted, the rest of the chain is assumed invalid, and thus the digital signature on the message is considered invalid 453.

If the signature on the certificate 510/516 (FIG. 12) verifies, the next tests 452 are on the content of the certificate. If the current date falls between the “Not Valid Before” and “Not Valid After” dates 513/520 (FIG. 12), the key usage 511/517 (FIG. 12) includes the ability to digitally sign, and the length of the public key 514/521 (FIG. 12) conforms to certificate policy (e.g. 2,048 bits for RSA keys), then the certificate is considered valid. Process flow continues at the top of the loop 442 with the next certificate down in the trust chain. If any of these tests fail, the individual certificate, the trust chain, and the digital signature on the message are considered invalid 453. Note that the list of tests herein presented is not intended to be exhaustive.

Once all of the certificates in the chain have been verified and their content validated, the loop 442 terminates, and the signature on the message is deemed valid.

Process Flow for Certificate Revocation Status Checking

FIG. 7 presents an exemplary process flow for checking the revocation status of a sender's digital certificate and the full trust chain of CAs above it back to the root CA. In describing this process flow, reference is made to FIG. 12, an exemplary digital certificate trust chain block diagram providing sample contents of the digital certificates used by the authenticated e-mail system. The system sits in a loop 469 processing each certificate in the trust chain 500 (FIG. 12) from the root CA 540 (FIG. 12) down to the sending domain 560 (FIG. 12). For each such certificate, it first extracts 461 the “Issuer Name” 515/522 (FIG. 12) from the given certificate 550/560 (FIG. 12) in order to get the certificate of the CA that issued the given one 540/550 (FIG. 12). The system checks 462 to see if the Issuing CA certificate 540/550 (FIG. 12) contains a CRL Distribution Point 519/524 (FIG. 12). CRL Distribution is a standard X.509 certificate attribute; it points to the location of a current CRL, typically stored in the CA's directory.

If the Issuing CA's certificate does not contain a CRL Distribution Point, the local configuration is checked for the URL either to a CRL or the OCSP responder for the CA 463. If the configuration specifies use of an OCSP responder, the information from the certificate currently being evaluated is sent to the OCSP responder for validation 464. The result of the OCSP responder's validation 465 is made available as the revocation status. Upon determination that any of the certificates in the trust chain is revoked 465/468, the loop terminates, and the revocation status check is understood to have failed 472.

If rather than an OCSP configuration, there is a URL (universal resource locator) pointing to a current CRL in the configuration of the authenticated e-mail system, the system first decides based on a configuration parameter, whether a new CRL needs to be fetched or whether the existing cached one, if any, is still valid 466. If the currently cached CRL is stale, or there is currently no CRL available locally, a current one is fetched from the LDAP directory pointed to by the URL 470. The CA's signature on the CRL is verified 467 per the process outlined in FIG. 6, steps 443 through 446.

Using the current CRL, the system checks to see 468 whether the sender's certificate serial number 512/518 (FIG. 12) is listed oil the CRL. If so, the certificate has been revoked, processing stops, and the certificate chain has failed the revocation check 472. Otherwise, the certificate is valid, and the loop continues with the next certificate in the chain 471. Once all the certificates in the chain have been checked and found not to have been revoked, processing completes, and the sender's certificate is deemed to be valid 473.

Process Flow for Abuse Reporting

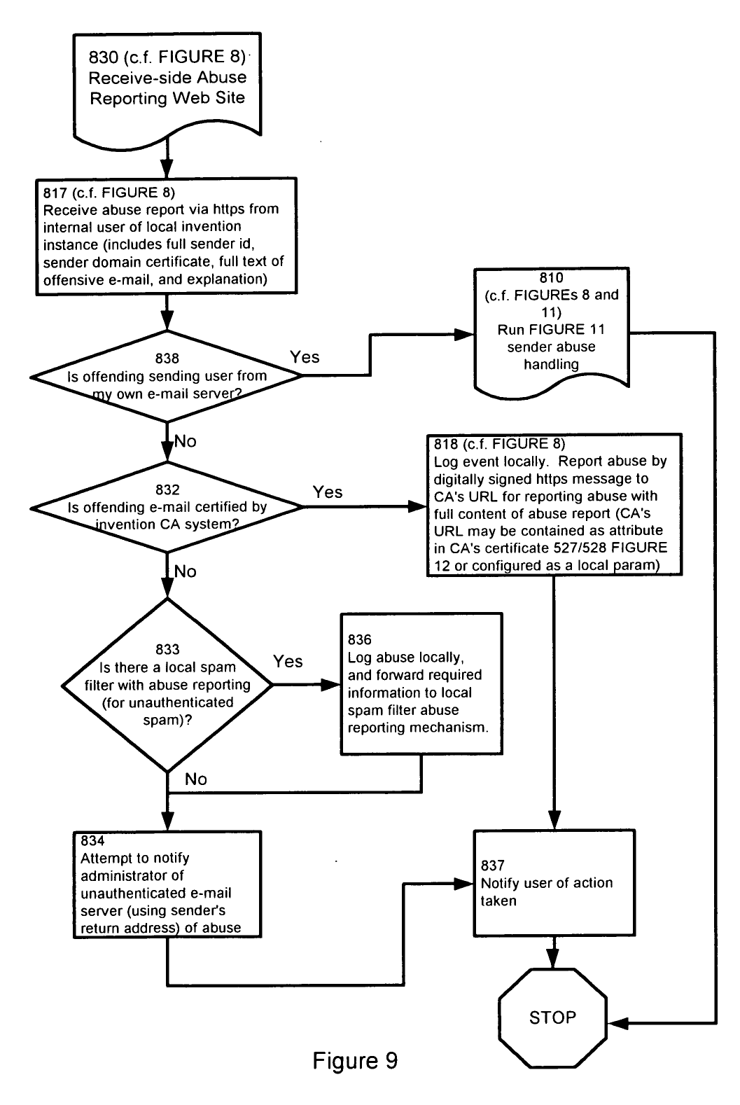

FIGS. 9 through 11 present an exemplary process flow for a member of the community served by the authenticated e-mail system to report abuse by another member of the community, and for the policy enforcement actions that result.

FIG. 9 presents an exemplary process flow for a receiving user 819 (c.f. FIG. 8, also referred to as “offended user”) to report abuse (e.g. spam) from a sending user (also referred to as the “offending user”). The receiving authenticated e-mail system hosts a web site for users to report abuse 830 (c.f. FIG. 8). The system receives a post of a complaint 817 (c.f. FIG. 8) from the offended user 819 (c.f. FIG. 8) via https (hypertext transfer protocol secure). The complaint contains the full e-mail address of the sender, the sending domain's certificate, the full text of the offensive e-mail including attachments, and a prose explanation of the complaint by the user.

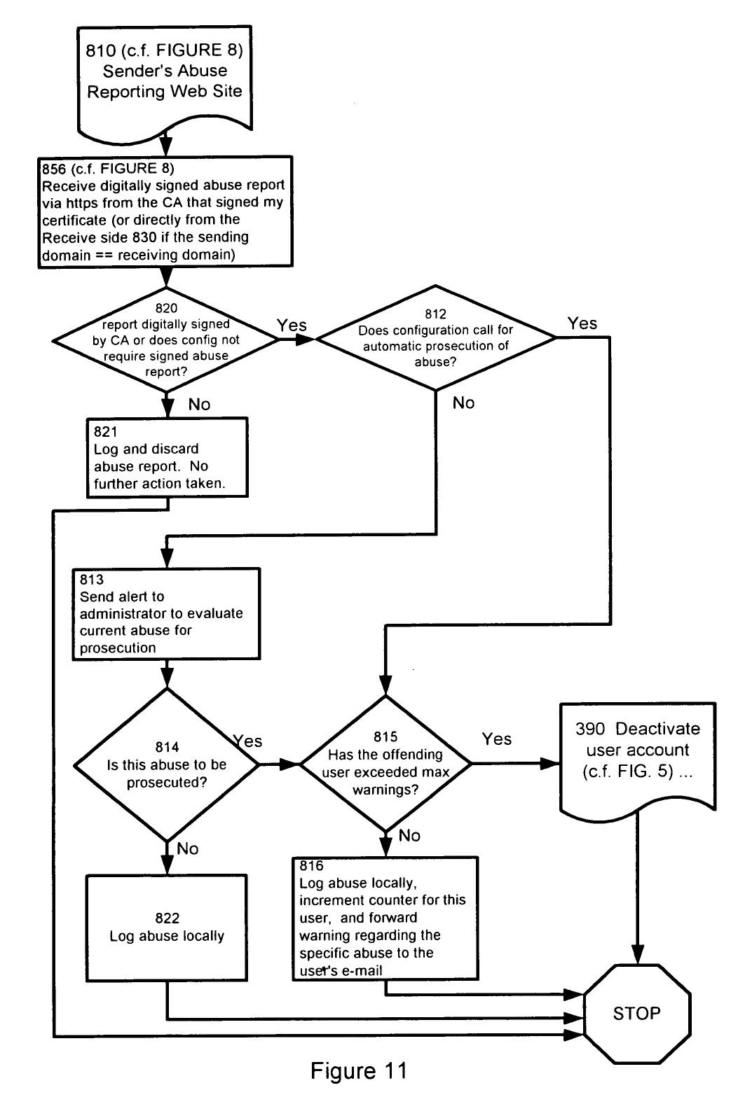

If the offending user (sender) has an account on the same e-mail domain as the offended user (receiver) 838, the problem is handled locally—that is, the abuse reporting system of the sending domain 810 (c.f. FIG. 8) executes immediately on the complaint (refer to FIG. 11), without the intervening step of the Issuing CA becoming involved.

If the sending domain is different, the receiving system checks the trust chain of the signed message to see if the certificate used to sign the offending message was issued by a CA authorized to participate in the trust domain of the authenticated e-mail environment 832.

If the Issuing CA is authorized to participate in the trust domain of the authenticated e-mail environment, the event is logged locally at the receiving system, and the full content of the complaint is reported to the issuing CA's abuse reporting site 850 (FIG. 8) in a digitally signed message from the receiving system via https 818 (c.f. FIG. 8). The CA's URL for reporting abuse may be contained as an attribute in the CA's certificate 527/528 (FIG. 12) or configured as a local configuration parameter of the authenticated e-mail system.

If the Issuing CA is not authorized to participate in the trust domain of the authenticated e-mail environment, the abuse report cannot be propagated through the authenticated e-mail environment, since the sender was not running a properly certified authenticated e-mail system. Rather, abuse may be reported to the abuse notification area of a local spam-filter 190 (FIG. 1), if one is configured 833, 836. In either case, using the return address of the malicious sender to identify the sending e-mail system, the abuse reporting system attempts to notify the administrator of the sending e-mail system that the malicious user while certified, appears to be abusing the system 834.

The current disposition of the abuse is reported back to the offended (receiving) user 837.

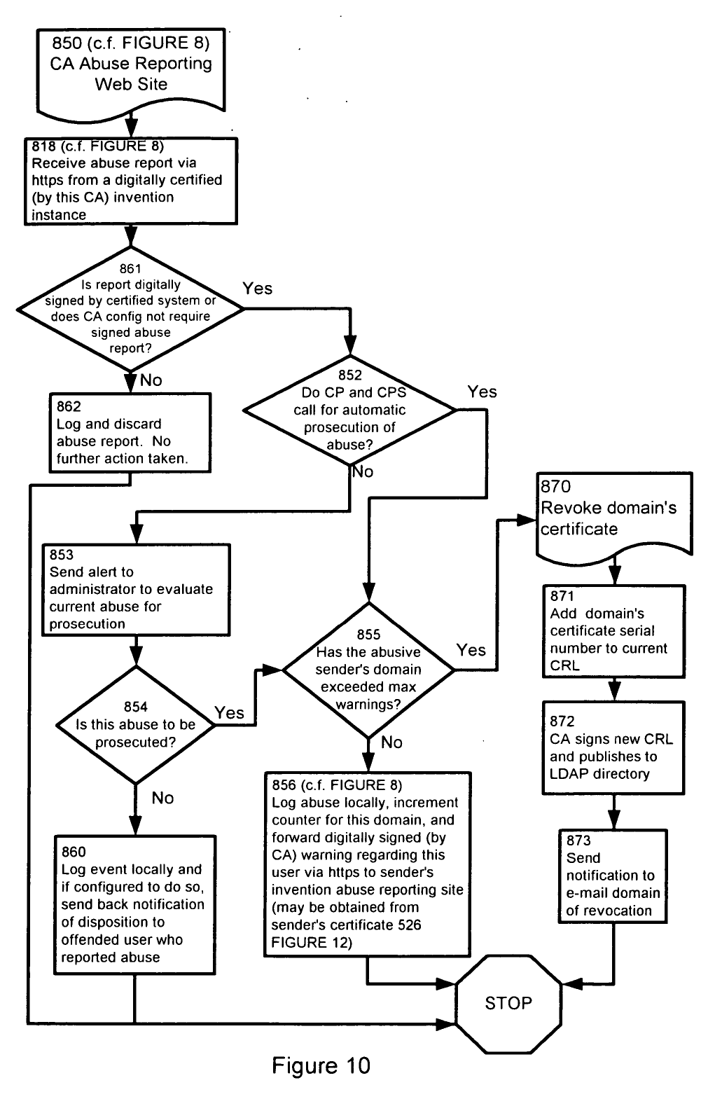

FIG. 10 presents an exemplary process flow for the abuse reporting web site 850 (FIG. 8) of a CA system in the trust domain of the authenticated e-mail environment 195 (c.f. FIG. 1). The CA's abuse reporting site 850 (c.f. FIG. 8) receives a digitally signed abuse report 818 (FIG. 8) from the receiver of the offending message via https. If the message is not validly signed by a valid receiving system, a configuration parameter of the CA abuse reporting site determines 861 whether to discard the message and only log it 862, or take action on it in either case.

If the CA's CP and CPS prescribe manual processing of abuse reports 852, an alert is sent along with the full content of the complaint to the CA administrator to evaluate for prosecution 853. If in the latter case, the administrator, upon review of the complaint, decides against prosecution 854, the event is logged locally, and if configured to do so, a notification of the disposition of the complaint is sent back to the offended user 819 (FIG. 8) who reported the abuse 860.

If the CA's CP and CPS call for automatic abuse report processing, or if the CA administrator manually decides to prosecute an abuse claim 854, action is taken against the offending sender. If the abusive sender's domain 150 (FIG. 1) has exceeded the maximum allowed number of warnings as determined by the CA's configuration 855, the sending domain's certificate is immediately revoked 870. Otherwise, 856 (c.f. FIG. 8) the complaint is logged locally, the counter for this domain is incremented, and the complaint is digitally signed by the CA and forwarded on via https to the URL of the sender's abuse reporting site 810. The sender's certificate 560 (FIG. 12) may contain the URL of its abuse reporting site 526 (FIG. 12).

If the CA revokes the sender's certificate 870, the sender's certificate serial number 512 (FIG. 12) is added to the CA's current CRL 871. The CA signs the CRL and publishes it 872 via LDAP to its CRL Distribution Point 519/524 (FIG. 12) for processing by other members of the community of the authenticated e-mail environment. The CA sends a notification 873 of the certificate revocation to the sender's domain 150 (FIG. 1).

FIG. 11 presents an exemplary process flow for the abuse reporting web site 810 hosted by the authenticated e-mail system running in the offending e-mail sender's domain 150 (FIG. 1). The abuse reporting site 810 (c.f. FIG. 8) receives the abuse report, either via https from the CA that signed its certificate 195 (FIG. 1), 850 (FIG. 8), or directly from the receive-side abuse reporting site 830 (FIG. 8) in the case where the sending domain is the same as the receiving domain 856 (c.f. FIG. 8).

If the abuse report is not validly digitally signed by the CA that issued the certificate to the sending system, and the sending system's abuse reporting site requires validly signed abuse reports 820, the report is logged and discarded with no further action taken 821.

If the sending system's configuration prescribes manual processing of abuse reports 812, an alert is sent along with the full content of the complaint to the system administrator to evaluate for prosecution 813. If in the latter case, the administrator, upon review of the complaint, decides against prosecution 814, the event is logged locally, and no further action is taken 822.

If the sending system's configuration calls for automatic abuse report processing, or the system administrator decides to prosecute the complaint in the manual case, action is taken against the offending sender. If the abusive sender has exceeded the maximum allowed number of warnings as determined by the local configuration 815, the sending user's e-mail account is deactivated 390 (FIG. 5). Otherwise, the complaint is logged locally, the abuse counter for the offending user is incremented, and a warning regarding the abuse is sent to the offending user's e-mail 816.

The various embodiments of the invention may be implemented as a sequence of computer implemented steps or program modules running on a computing system and/or as interconnected machine logic circuits or circuit modules within the computing system. It is well known in the art that e-mail systems and authentication systems may be implemented as programmed instructions used on computers. It is also further well known to realize methods for e-mail systems and authentication systems as programmed instructions and to embody such programmed instructions on computer readable medium or media or as equivalent electronic waveforms. Such media may be software products or incorporated into other edifices. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

The above specification, examples and data provide a complete description of the manufacture and use of the composition of the invention. Since many embodiments of the invention can be made without departing from the spirit or scope of the invention, the invention resides in the claims hereinafter appended.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. An e-mail messaging system comprising
a first authenticated e-mail system having first programmed instructions operable to perform the actions of:
(a) receiving a signed message comprising a digital signature;
(b) verifying the digital signature to produce a determination as to whether the digital signature was generated on a second authenticated e-mail system having second programmed instructions operable to perform the actions of:
(A) checking that an unsigned message is received from a user having an account on the second authenticated e-mail system wherein the account is activated;
(B) testing to establish whether the unsigned message conforms to a set of rules wherein the set of rules prohibit spamming and
(C) responsive to a results of the checking and of the testing, performing the actions of:
deactivating the account pursuant to a breach of the set of rules and
digitally signing the unsigned message to produce the signed message and sending the signed message towards the first authenticated e-mail system pursuant to a conformance with the set of rules; and
(c) responsive to the determination, performing an action selected from a list consisting of fast-tracking at least a first part of the signed message and diverting at least a second part of the signed message.

2. The messaging system of claim 1 wherein the verifying further comprises
checking that the signed message conforms to a message specification and to a digital signature standard format.

3. The messaging system of claim 2 wherein
the message specification is selected from a list consisting of an S/MIME message specification and a MIME message specification and further wherein the digital signature standard format is selected from a list consisting of an S/MIME specification and a PKCS #7 specification.

4. The messaging system of claim 1 wherein the verifying further comprises
confirming that the second authenticated e-mail system was digitally signed into a trusted public key infrastructure.

5. The messaging system of claim 4 wherein the first programmed instructions are further operable to perform the actions of:
reporting an abuse to a certificate authority, the certificate authority having issued a digital certificate to the second authenticated e-mail system whereby a compliance is enforced.

6. The messaging system of claim 1 wherein the set of rules further prohibits exceeding an allowed message count per time interval.

7. The messaging system of claim 4 wherein the
the trusted public key infrastructure comprises a root trusted signer and further wherein the confirming further comprises ascertaining that a digital certificate issued to the second authenticated e-mail system by a certification authority subordinate to the root trusted signer has not been revoked.

8. An assemblage of computer executable codes embodied on at least one computer-readable medium for implementing an e-mail messaging system comprising:
a first set of programmed instructions operable to:
(A) check that an unsigned message is received from a user having an activated account;
(B) test whether the unsigned message conforms to a set of rules that prohibit spamming;
(C) deactivate the account pursuant to a breach of the set of rules;
(D) digitally sign the unsigned message to produce a signed message comprising a digital signature and send the signed message towards an authenticated e-mail system pursuant to a conformance with the set of rules;
(E) repeat the operations (A) through (D) and
a second set of programmed instructions operable to:
(a) receive the signed message;
(b) verify the digital signature;
(c) fast-track at least a first part of the signed message and
(d) divert at least a second part of the signed message.

9. The assemblage of claim 8 further comprising programmed instructions operable to
check that the signed message conforms to a message specification and a digital signature standard format.

10. The assemblage of claim 9 wherein
the message specification is selected from a list consisting of an S/MIME message specification and a MIME message specification and further wherein
the digital signature standard format is selected from a list consisting of an S/MIME specification and a PKCS #7 specification.

11. The assemblage of claim 8 further comprising instructions programmed operable to
confirm that the digital signature was generated on an authenticated e-mail system digitally signed into a trusted public key infrastructure.

12. The assemblage of claim 1 further comprising programmed instructions operable to
report an abuse to a certificate authority, the certificate authority having issued a digital certificate to the authenticated e-mail system.

13. The assemblage of claim 8 wherein
the set of rules prohibits exceeding an allowed message count per time interval.

14. The assemblage of claim 11 further comprising programmed instructions
wherein the trusted public key infrastructure comprises a root trusted signer and
wherein assemblage further comprises programmed instructions operable to ascertain that a digital certificate issued by a certification authority subordinate to the root trusted signer to the authenticated e-mail system has not been revoked.

15. A method for an e-mail messaging system comprising the acts of
(a) receiving a signed message comprising a digital signature;
(b) verifying the digital signature to produce a determination as to whether the digital signature was generated on an authenticated e-mail system having programmed instructions operable to perform the acts of:
(A) checking that an unsigned message is received from a user having an account on the authenticated e-mail system wherein the account is activated;
(B) testing to establish whether the unsigned message conforms to a set of rules wherein the set of rules prohibit spamming and
(C) responsive to a results of the checking and of the testing, performing the actions of:
deactivating the account pursuant to a breach of the set of rules and
digitally signing the unsigned message to produce the signed message pursuant to a conformance with the set of rules; and
(c) responsive to the determination, performing an action selected from a list consisting of fast-tracking at least a first part of the signed message and diverting at least a second part of the signed message.

16. The method of claim 15 wherein the verifying further comprises
checking that the signed message conforms to a message specification selected from a first list consisting of an S/MIME message specification and a MIME message specification and
further wherein the verifying further comprises checking that the signed message further conforms to a digital signature standard format selected from a second list consisting of an S/MIME specification and a PKCS #7 specification.

17. The method of claim 15 wherein the verifying further comprises
confirming that the authenticated e-mail system was digitally signed into a trusted public key infrastructure.

18. The method of claim 17 further comprising
reporting an abuse to a certificate authority, the certificate authority having issued a digital certificate to the authenticated e-mail system whereby a compliance is enforced.

19. The method of claim 15 wherein the set of rules further prohibits exceeding an allowed message count per time interval.

20. The method of claim 17 wherein
the trusted public key infrastructure comprises a root trusted signer and further wherein the confirming further comprises ascertaining that a digital certificate issued by a certification authority subordinate to the root trusted signer to the authenticated e-mail system has not been revoked.
